(19) United States
(12) Patent Application Publication
(10) Pub. No.: US 2012/0095833 A1
(43) Pub. Date: Apr. 19, 2012

(54) Recommendation Engine

(75) Inventor: Donald Carl Bleyl, Powder Springs, GA (US)

(73) Assignee: Cox Communications, Inc., Atlanta, GA (US)

(21) Appl. No.: 12/903,296

(22) Filed: Oct. 13, 2010

(51) Int. Cl. G06Q 30/00

(52) U.S. Cl. 705/14.53; 705/14.66

(57) ABSTRACT

A recommendation may be provided. First, program content may be determined to suggest to a user. Next, it may be determined that the program content is currently unavailable on a content delivery system. Then a recommendation may be made to a provider of the program content to provide the currently unavailable program content to the content delivery system.

### BACKGROUND

Service providers may deliver content to a user over a content delivery system. For example, conventional content delivery systems distribute the content to a first user and a second user independently. In other words, the first user may watch a sports program while the second user may simultaneously watch a video-on-demand program. Furthermore, service providers may provide along with the content, a grid-like guide showing what content is available at what time.

### SUMMARY OF THE INVENTION

A recommendation may be provided. First, program content may be determined to suggest to a user. Next, it may be determined that the program content is currently unavailable on a content delivery system. Then a recommendation may be made to a provider of the program content to provide the currently unavailable program content to the content delivery system.

Both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment including a communications processor;

FIG. 2 is a block diagram of the communications processor;

FIG. 3 is a flow chart of a method for providing a recommendation; and

FIG. 4 shows a block diagram of a recommendation engine used to generate recommendations for end-users.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

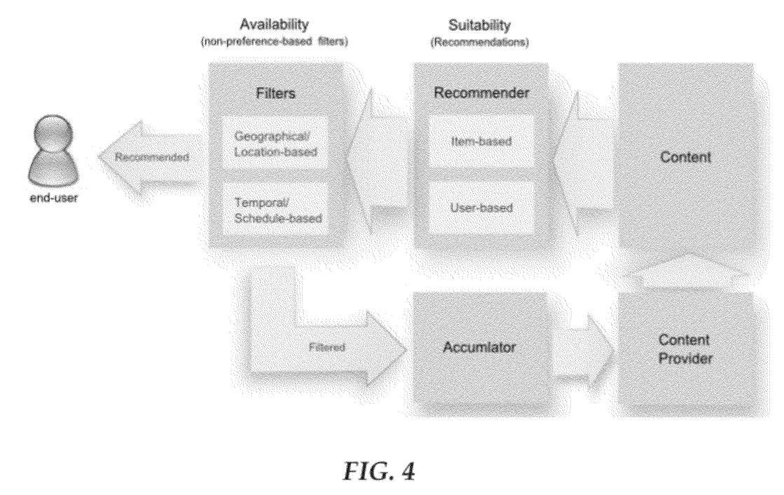

As shown in FIG. 4, recommendation engines may apply user-based, item-based or some combination of the two techniques to generate recommendations for end-users (e.g. video subscribers). Algorithms that may be used for this purpose may include Cosine Similarity, Pearson-R correlation, and k-nearest-neighbor. At some point in the recommendation process, a filter may be applied to limit the recommendations to items that are available to the end-user. Recommending items that are not available to the end user may result in a frustrating user experience. Examples of filters that may apply to video include removing programs from a recommendation list that are Video On Demand assets that have expired purchase windows, Broadcast TV that has already aired or is not scheduled, or local programming from other markets that is not available in the user's market.

Rather than completely discarding items that are unavailable, embodiments of the invention may capture items that would otherwise be recommended based on standard recommendations algorithms that rely on user preferences, feedback, attributes, or item attributes, but that are not being recommended because of lack of availability. By tracking the recommendation occurrence before filtering the unavailable out, embodiments of the invention may keep a running tally of the top programs that would be recommended if they were made available to a given market. This aggregated information, which could include the top 10% recommended programs that were not available, for example, could be made available to content providers to complement ratings information.

Recommendations for program content may be provided. Consistent with embodiments of the invention, instead of recommendations directed only to subscribers based on what content is currently available on a given content deliver system, a content recommendation based on what exists, but is currently unavailable on the given content deliver system may be generated and directed to a provider of the program content.

This recommendation could be used to augment ratings information and may server essentially as a supply chain recommendation. For example, two recommendations for each program content may be generated. One recommendation for subscribers (e.g. filtered by available items) and an another aggregate item-based recommendation for content providers (e.g. program content that would have been recommended frequently if the program content had been made available at the time on the given content deliver system.) The filtered recommendation may be presented to the user (e.g. subscriber) as a ‘Pick’. The recommendation for content providers may be aggregated into a list of items that would be recommended to subscribers if the items (e.g. program content) were available on the given content deliver system, and feed upstream as a recommendation to content providers. If the content providers know that the service provide would have recommended the items to subscribers on the content deliver system had the items been available on the content deliver system, the content providers may be more willing to make the items available to the content deliver system.

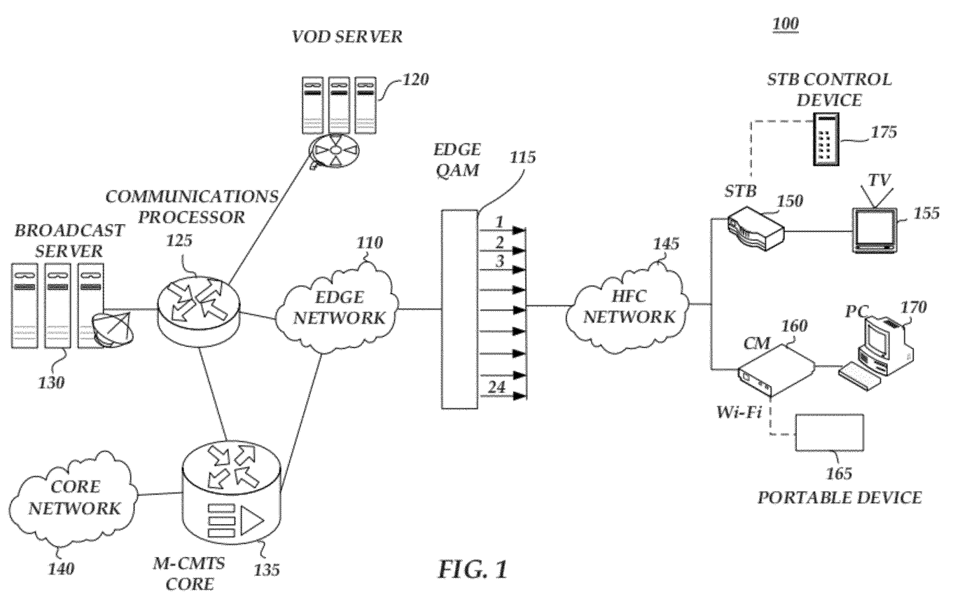

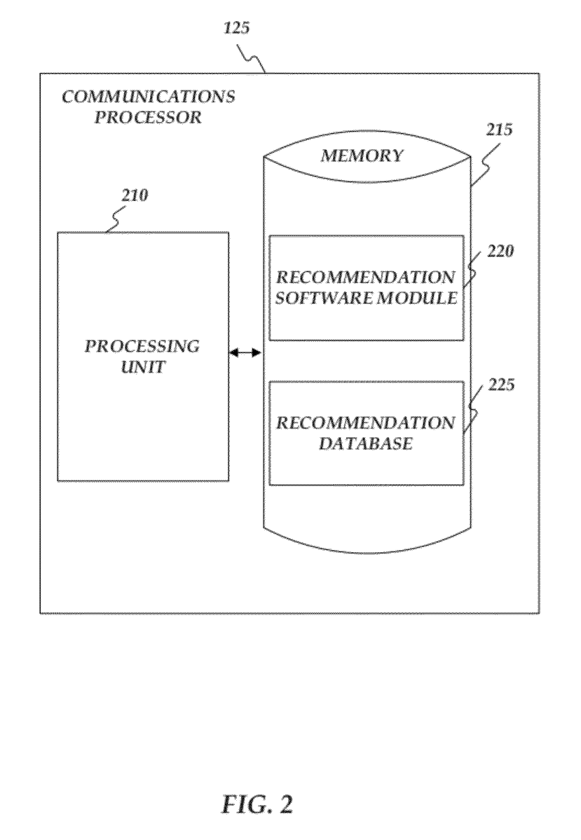

FIG. 1 is a block diagram of a content delivery system 100. All or a portion of system 100 may be operated by a system operator. The system operator may comprise, but is not limited to, service provider such as a cable television service provider, for example. Consistent with embodiments of the present invention, system 100 may comprise an edge network 110, an edge quadrature amplitude modulation (QAM) device 115, a video-on-demand (VOD) server 120, a communications processor 125, a broadcast server 130, a modular cable modem termination system (M-CMTS) core 135, and a core network 140. In addition, system 100 may comprise, a hybrid fiber-coax (HFC) network 145, a set-top-box (STB) 150, a television (TV) 155, a cable modem (CM) 160, a portable device 165, a personal computer (PC) 170, and a STB control device 175. Communications processor 125 will be discussed in greater detail below with respect to FIG. 2.

Edge network 110 may comprise, a network providing, for example, full-duplex, two-way broadband services including broadband video and audio, cable television services, or telecommunications services. Edge network 110 may provide data by utilizing network data formats including, for example, i) Internet protocol (IP); ii) Ethernet; iii) digital subscriber line (DSL); iv) asynchronous transfer mode (ATM); and v) virtual private network (VPN). Edge network 110 may utilize managed network services. Edge network 110 may comprise various components including, for example, i) servers; ii) switches; iii) routers; iv) gateways; v) hubs; vi) fiber optic cable; vii) copper cable; and viii) terminations. The aforementioned are examples and edge network 110 may comprise other configurations for broadband service delivery and data switching over system 100.

Edge QAM 115 may provide modulation for various encoding formats (e.g. for data, audio, and video) and may distribute the signal down multiple broadband channels. Edge QAM 115 may modulate signals in, for example, multi-channel quadrature amplitude modulation. Edge QAM 115 may support broadcast and narrowcast with multi-program transport stream (MPTS) pass-through and single-program transport stream (SPTS) to MPTS multiplexing. Edge QAM 115 may meet data-over-cable service interface specification (DOCSIS) and downstream radio frequency interface (DRFI) performance specifications. Furthermore, edge QAM 115 may provide video over internet protocol and moving pictures expert group (MPEG) video simultaneously. Edge QAM 115 may provide various data switching functions and enable two-way, full-duplex communication within the broadband network. Edge QAM 115 may modulate and distribute broadcast multimedia services including, for example, i) a broadcast multi-media service; ii) a high-definition multimedia service; iii) a digital television multimedia service; iv) an analog multimedia service; v) a VOD service; vi) a streaming video service; vii) a multimedia messaging service; viii) a voice-over-internet protocol service (VoIP); ix) an interactive multimedia service; and x) an e-mail service. The aforementioned are examples and edge QAM 115 may comprise other configurations for different broadband and data services.

VOD server 120 may perform processes for providing video entertainment on demand. VOD server 120 may take MPEG compressed video off a hard disk or a networked service, format it into MPEG-TS packets inside a user datagram protocol (UDP) packet, and send it into edge network 110. Edge QAM 115 may receive the UDP packets, where Internet protocol (IP) encapsulation may be removed. The MPEG packets may be forwarded down one QAM channel on edge QAM 115 and onto HFC network 145.

Broadcast server 130 may perform processes for providing broadcast services. Broadcast server 130 may use a broadcast signal and a narrowcast signal to deliver broadcast services to a broadcast system. Broadcast server 130 may receive video, audio, and data from fiber optic input, wireless input, recorded tape, recorded digital video disc, or satellite input. Broadcast server 130 may utilize digital signal formats and analog signal formats. Furthermore, broadcast server 130 may comprise a specialized receiver and data switching equipment for broadband distribution including, for example, using switched digital technology for broadcast video delivery to digital set-tops. In addition, broadcast server 130 may provide broadband multimedia services including, for example, i) the broadcast multi-media service; ii) the high-definition multimedia service; iii) the digital television multimedia service; iv) the analog multimedia service; v) the VOD service; vi) the streaming video service; vii) the multimedia messaging service; viii) the voice-over-internet protocol service (VoIP); ix) the interactive multimedia service; and x) the e-mail service. The aforementioned are examples and broadcast server 130 may comprise other components and systems for providing broadcast services in system 100.

M-CMTS core 135 may receive IP datagrams from core network 140. M-CMTS core 135 may then forward these IP datagrams to either a single QAM channel within edge QAM 115 with traditional DOCSIS encapsulation, or may forward the IP datagrams to multiple QAM channels within edge QAM 115, for example, using DOCSIS bonding. M-CMTS core 135 may support DOCSIS features and end-to-end IP within a next generation network architecture (NGNA), for example.

Core network 140 may comprise any data or broadband network that may provide data and services to edge network 110, communications processor 125, broadcast server 130, or M-CMTS core 135. For example, core network 140 may comprise the Internet. In addition, core network 140 may comprise various components including, for example, i) servers; ii) switches; iii) routers; iv) gateways; v) hubs; vi) fiber optic cable; vii) copper cable; and viii) terminations. The aforementioned are examples and core network 140 may comprise other components and may supply other services using various other formats.

HFC network 145 may comprise a communications network (e.g. a cable TV network) that uses optical fiber, coaxial cable, or an optical fiber coaxial cable combination. Fiber in HFC network 120 may provide a high-speed backbone for broadband services. Coaxial cable may connect end users (e.g. subscribers) in HFC network 120 to the backbone. Such networks may use, for example, matching DOCSIS cable modems at a head end and at an end user's premises. Such a configuration may provide bi-directional paths and Internet access.

STB 150 may comprise a single component or a multi-component system for receiving broadband services. STB 150 may comprise a service consumer system combining several components including, for example, a set top box, cable modem 160, a network interface unit, a residential gateway, a terminal unit, a scrambler/descrambler, a digital storage media unit, an input/output port, a display device, a keyboard, and a mouse. STB 150 may encode and decode digital and analog signals, and provide interface capability for other components. STB 150 may utilize various operating systems and other software components. The end user's premises may contain STB 150. STB 150 may include all the functionality provided by a cable modem, such as CM 160, in one component and attach to TV 155, for example.

TV 155 may comprise an end use device for displaying delivered broadband services. TV 155 may comprise, for example, a television, a high definition television, a liquid crystal display unit (LCD), a video projection unit, or PC 170. The aforementioned are examples and TV 155 may comprise other display devices for delivered broadband services.

CM 160 may comprise, for example, a cable modem, a network server, a wireless fidelity data switch, or an Ethernet switch. CM 160 may provide data services to the user by accessing DOCSIS services from system 100. CM 160 may provide Internet access, video, or telephone services. The aforementioned are examples and CM 160 may comprise other data delivery devices.

Portable device 165 or PC 170 may comprise any personal computer, network switch, wireless switch, network hub, server, personal digital assistant, and home computing device. Portable device 165 or PC 170 may serve as user devices for data access from system 100. Portable device 165 and PC 170 may transmit and receive data and services from system 100.

STB control device 175 may comprise any input and output device for interfacing with STB 150. For example, STB control device 175 may be a remote control for using STB 150. STB control device 175, after proper programming, may interface with STB 150.

Furthermore, system 100 maybe configured to utilize Open Cable Applications Platform (OCAP.) OCAP was developed by Cable Television Laboratories, Inc. of Louisville, Colo. 80027-9750, as a common interactive TV platform. OCAP is a specification for a middleware software layer that enables application developers, interactive television services, and various other products to run interactive applications on content delivery system such as television systems.

Consistent with embodiments of the present invention, the aforementioned memory, processing unit, and other components may be implemented in a content delivery system, such as system 100 of FIG. 1. Any suitable combination of hardware, software, and/or firmware may be used to implement the memory, processing unit, or other components. By way of example, the memory, processing unit, or other components may be implemented with communications processor 125, in combination with system 100. The aforementioned system and processors are examples and other systems and processors may comprise the aforementioned memory, processing unit, or other components, consistent with embodiments of the present invention.

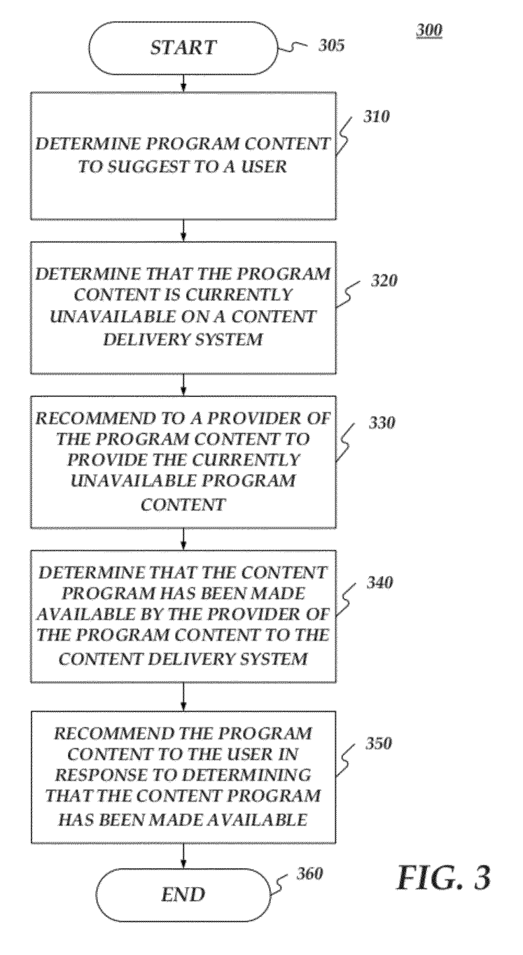

FIG. 2 shows communications processor 125 of FIG. 1 in more detail. As shown in FIG. 2, communications processor 125 may include a processing unit 210 and a memory unit 215. Memory 215 may include a recommendation software module 220 and a recommendation database 225. While executing on processing unit 210, recommendation software module 220 may perform processes for providing a recommendation, including, for example, one or more stages included in method 300 described below with respect to FIG. 3. Furthermore, any of recommendation software module 220 and recommendation database 225 may be executed on or reside in any element shown in FIG. 1.

Communications processor 125 (“the processor”) may be implemented using a personal computer, a network computer, a mainframe, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

FIG. 3 is a flow chart setting forth the general stages involved in a method 300 consistent with an embodiment of the invention for providing a recommendation. Method 300 may be implemented using communications processor 125 as described in more detail above with respect to FIG. 2. Ways to implement the stages of method 300 will be described in greater detail below.

Method 300 may begin at starting block 305 and proceed to stage 310 where communications processor 125 may determine program content to suggest to a user. For example, a service provider may operate content delivery system 100. Specifically, the service provider may receive content from a content provider and then make this content available to the user (e.g. subscriber to content delivery system 100) over, for example, set top box 150. In order to determine program content to suggest to the user, service provider may consult a profile of the user.

The profile may be based upon behavior of the user. In other words, communications processor 125 may monitor the user's interaction with content delivery system 100 to gather implicit information with respect to the user. From this gathered implicit information, communications processor 125 may be able to suggest content in which the user may be interested. For example, the implicit information may comprise what movies the user has purchased within a given time period over content delivery system 100. Furthermore, the implicit information may comprise what services the user has subscribed to with the service provider over content delivery system 100. In addition, the implicit information may comprise how long a user watched a particular program over content delivery system 100 or may be based on a media guide search performed by the user on content delivery system 100. The aforementioned implicit information types are examples and other implicit information types may be used.

Furthermore, in addition to implicit information, the profile may be based upon explicit information received from the user. For example, the received explicit information may comprise, but is not limited to, a rating given by the user to a particular program. In addition, the received explicit information may comprise answers to a questionnaire completed by the user. The questionnaire may be designed to extract information from the user directed toward discovering what types of content in which the user may be interested.

From the implicit information, the explicit information, or both, communications processor 125 may determine program content to suggest to the user. In other words, based on the implicit information, the explicit information, or both, communications processor 125 may decide that there is content (e.g. the program content) that the user may be interested in consuming (e.g. seeing.)

From stage 310, where communications processor 125 determines the program content to suggest to the user, method 300 may advance to stage 320 where communications processor 125 may determine that the program content is currently unavailable on content delivery system 100. For example, while communications processor 125 may decide that the user may be interested in consuming (e.g. seeing) the program content, the program content may not be content the system operator of content delivery system 100 offers to subscribers (e.g. users) of the content delivery system 100. Consequently, the system operator of content delivery system 100 may not wish to suggest the program content to the user since the system operator does not offer it.

Once communications processor 125 determines that the program content is currently unavailable on content delivery system 100 in stage 320, method 300 may continue to stage 330 where communications processor 125 may recommend to a provider of the program content to provide the currently unavailable program content to content delivery system 100. For example, while communications processor 125 may decide that the user may be interested in consuming (e.g. seeing) the program content, the system operator of content delivery system 100 may not wish to just drop the suggestion. Instead, the system operator of content delivery system 100 may wish to let a content provider of the program content know that if the program content were available on content delivery system 100, the system operator of content delivery system 100 may suggest to the user to consume the program content. Consequently, the system operator of content delivery system 100 may recommend to the content provider of the program content to provide the currently unavailable program content to content delivery system 100.

After communications processor 125 recommends to the provider of the program content to provide the currently unavailable program content to content delivery system 100 in stage 330, method 300 may proceed to stage 340 where communications processor 125 may determine that the content program has been made available by the provider of the program content to content delivery system 100 in response to recommending to the provider of the program content to provide the currently unavailable program content to content delivery system 100. For example, because the content provider of the program content may wish for the operator of content delivery system 100 to suggest to the user to consume the content program, the provider of the program content may now make the program content available to delivery system 100.

From stage 340, where communications processor 125 determines that the content program has been made available by the provider of the program content to content delivery system 100 in response to recommending to the provider of the program content to provide the currently unavailable program content to content delivery system 100, method 300 may advance to stage 350 where communications processor 125 may recommend the program content to the user in response to determining that the program content has been made available by the provider of the program content to content delivery system 100. For example, because the provider of the program content has now made the program content available to delivery system 100, the operator of content delivery system 100 may recommend to the user to consume the content program.

Once communications processor 125 recommends the program content to the user in response to determining that the program content has been made available by the provider of the program content to content delivery system 100 in stage 350, method 300 may then end at stage 360.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a recommendation, the method comprising:
determining program content to suggest to a user;
determining that the program content is currently unavailable on a content delivery system; and
recommending to a provider of the program content to provide the currently unavailable program content to the content delivery system.

2. The method of claim 1, wherein determining the program content to suggest to the user comprises determining the program content to suggest to the user based on a profile of the user.

3. The method of claim 1, wherein determining the program content to suggest to the user comprises determining the program content to suggest to the user based on a profile of the user, the profile being based upon behavior of the user.

4. The method of claim 1, wherein determining the program content to suggest to the user comprises determining the program content to suggest to the user based on a profile of the user, the profile being based upon implicit information received from the user.

5. The method of claim 1, wherein determining the program content to suggest to the user comprises determining the program content to suggest to the user based on a profile of the user, the profile being based upon implicit information received about the user, the implicit information comprising what movies the user has purchased.

6. The method of claim 1, wherein determining the program content to suggest to the user comprises determining the program content to suggest to the user based on a profile of the user, the profile being based upon implicit information received about the user, the implicit information comprising what services the user has subscribed to.

7. The method of claim 1, wherein determining the program content to suggest to the user comprises determining the program content to suggest to the user based on a profile of the user, the profile being based upon implicit information received about the user, the implicit information comprising how long a user watched a particular program.

8. The method of claim 1, wherein determining the program content to suggest to the user comprises determining the program content to suggest to the user based on a profile of the user, the profile being based upon implicit information received about the user, the implicit information comprising a media guide search performed by the user.

9. The method of claim 1, wherein determining the program content to suggest to the user comprises determining the program content to suggest to the user based on a profile of the user, the profile being based upon explicit information received from the user.

10. The method of claim 1, wherein determining the program content to suggest to the user comprises determining the program content to suggest to the user based on a profile of the user, the profile being based upon explicit information received from the user, the explicit information comprising a rating given by the user.

11. The method of claim 1, wherein determining the program content to suggest to the user comprises determining the program content to suggest to the user based on a profile of the user, the profile being based upon explicit information received from the user, the explicit information comprising user provided answers to questions.

12. The method of claim 1, wherein determining that the program content is currently unavailable on the content delivery system comprises determining that the program content is currently unavailable on the content delivery system comprising a hybrid fiber-coax (HFC) network.

13. The method of claim 1, further comprising determining that the content program has been made available by the provider of the program content to the content delivery system in response to recommending to the provider of the program content to provide the currently unavailable program content to the content delivery system.

14. The method of claim 13, further comprising recommending the program content to the user in response to determining that the content program has been made available by the provider of the program content to the content delivery system.

15. A computer-readable medium which stores a set of instructions which when executed performs a method for providing a recommendation, the method executed by the set of instructions comprising:
determining program content to suggest to a user;
determining that the program content is currently unavailable on a content delivery system;
recommending to a provider of the program content to provide the currently unavailable program content to the content delivery system;
determining that the content program has been made available by the provider of the program content to the content delivery system in response to recommending to the provider of the program content to provide the currently unavailable program content to the content delivery system; and
recommending the program content to the user in response to determining that the content program has been made available by the provider of the program content to the content delivery system.

16. The computer-readable medium of claim 15, wherein determining the program content to suggest to the user comprises determining the program content to suggest to the user based on a profile of the user, the profile being based upon implicit information received from the user.

17. The computer-readable medium of claim 15, wherein determining the program content to suggest to the user comprises determining the program content to suggest to the user based on a profile of the user, the profile being based upon implicit information received about the user, the implicit information comprising at least one of the following: what movies the user has purchased, what services the user has subscribed to, how long a user watched a particular program, and comprising a media guide search performed by the user.

18. The computer-readable medium of claim 15, wherein determining the program content to suggest to the user comprises determining the program content to suggest to the user based on a profile of the user, the profile being based upon explicit information received from the user.

19. The computer-readable medium of claim 15, wherein determining the program content to suggest to the user comprises determining the program content to suggest to the user based on a profile of the user, the profile being based upon explicit information received from the user, the explicit information comprising at least one of the following: a rating given by the user and user provided answers to questions.

20. A system for providing a recommendation, the system comprising:
a memory storage; and
a processing unit coupled to the memory storage, wherein the processing unit is operative to:
determine program content to suggest to a user, wherein the processing unit being operative to determine program content to suggest to a user comprises the processing unit being operative to determine the program content to suggest to the user based on a profile of the user, the profile being based upon;
explicit information received from the user, the explicit information comprising a rating given by the user and user provided answers to questions, and
implicit information received about the user, the implicit information comprising what movies the user has purchased, what services the user has subscribed to, how long a user watched a particular program, and comprising a media guide search performed by the user;
determine that the program content is currently unavailable on a content delivery system comprising a hybrid fiber-coax (HFC) network;
recommend to a provider of the program content to provide the currently unavailable program content to the content delivery system;
determine that the content program has been made available by the provider of the program content to the content delivery system in response to recommending to the provider of the program content to provide the currently unavailable program content to the content delivery system; and
recommend the program content to the user in response to determining that the content program has been made available by the provider of the program content to the content delivery system.
